(19) United States
(12) Patent Application Publication
(10) Pub. No.: US 2003/0120956 A1
(43) Pub. Date: Jun. 26, 2003

(54) Authorization method and system for storing and retrieving data

(75) Inventors: Hung-Liang Chiu, Taipei (TW); Wen-Chee Yu, Taipei (TW)

Correspondence Address: EDWARDS & ANGELL, LLP, P.O. BOX 9169, BOSTON, MA, 02209, US

(73) Assignee: Inventec Corporation

(21) Appl. No.: 10/026,596

(22) Filed: Dec. 20, 2001

(51) Int. Cl. H04L 9/00

(52) U.S. Cl. 713/202

(57) ABSTRACT

An authorization method and system for storing and retrieving data are proposed, in which the authorization method is applied to the authorization system, which connects a terminal device to a resource system established by an application service provider (ASP) via a network, so as to allow the ASP to authorize a user at the terminal device to interact therewith for data storage and retrieval. In the use of the authorization method and system, a client terminal with no authorization is inhibited for storing and retrieving application software provided by an application service provider (ASP), and costs for an enterprise in purchasing authorization from the ASP can be significantly reduced.

### FIELD OF THE INVENTION

The present invention relates to authorization methods and systems for storing and retrieving data, and more particularly, to an authorization method and system for storing and retrieving data, in which an application server provider authorizes a terminal device to interact therewith for data storage and retrieval.

### BACKGROUND OF INVENTION

Rapid development of electronic information and internet systems allows trades to be conducted by interaction and application between computers and communication networks. Therefore, an enterprise resource planning (ERP) system is introduced to a commercially automated enterprise for integrating internal information systems of various departments in the enterprise, so as to effectively make use of resources in the enterprise.

An application service provider (ASP) of the ERP system provides a network interface for supporting its application program with client/server architecture thereon, so as to authorize ERP products to clients in a secure manner as to directly submit product requests and access associated information. Some other products are authorized to commercially cooperated partners, allowing information to be accessed and product requests to be submitted in a self-service manner, so as to improve correlation between the ASP and the cooperated partners. For example, a R/3 internet application components system operates in connection with internet, that is, after a commercially cooperated partner fills a virtual shopping trolley with goods, it can apply for a quotation, and investigate if the goods are all in stock and time for delivering the goods. In operation of the R/3 system, all of the information herein can be obtained through an interface connected to a R/3 database, and other modules in the R/3 system can receive trades transmitted through a website.

Storage and retrieval of software provided by such a ERP system provider can be implemented by a user in a manner that, firstly, a start-up program provided by the ERP system provider is installed in a terminal device of the user; secondly, user's authorization is established in a client database provided by the ERP system provider; and thirdly, the user pays the ERP system provider for purchasing the user's authorization.

Since the user needs to install the start-up program in the terminal device and pay for the user's authorization provided by the ERP system provider, this therefore increases costs for an enterprise in authorization purchasing and start-up program installation.

Therefore, how to reduce the enterprise costs for purchasing the authorization and installing the start-up program is a critical problem to solve.

### SUMMARY OF THE INVENTION

A primary objective of the present invention is to provide an authorization method and system for storing and retrieving data, which can reduce enterprise costs in purchasing authorization for storing and retrieving application software provided by an application service provider.

Another objective of the present invention is to provide an authorization method and system for storing and retrieving data, which can simplify processes for installing and arranging a start-up program required for storing and retrieving application software provided by an application service provider.

In accordance with the foregoing and other objectives, the present invention proposes an authorization method and system for storing and retrieving data. The authorization method for storing and retrieving data of the invention is applied to an authorization system for connecting a terminal device to a resource system established by an application service provider (ASP) via a network, so as to allow the ASP to authorize a user at the terminal device to interact therewith for data storage and retrieval, wherein the authorization system is pre-constructed with a database and an authorization account. The database includes a plurality of user's data for identifying the user submitting a request for loginning the resource system, and the authorization account is used for authorizing the user to store and retrieve the resource system.

The authorization method for storing and retrieving data comprises the steps of: (1) receiving user's data inputted by the user to the terminal device via the authorization system; (2) comparing the user's data transmitted from the terminal device with the user's data stored in the database via the authorization system, wherein if no user's data in the database matches the user's data transmitted from the terminal device, then step (3) is followed; if one of the user's data in the database matches the user's data transmitted from the terminal device, then step (4) is followed; (3) sending a message of failure in loginning the resource system via the authorization system to the terminal device, and allowing the user at the terminal device to re-input user's data for loginning the resource system; then returning to the step (1); and (4) sending an authorization account via the authorization system to the resource system, and transmitting data generated by the resource system to the terminal device, so as to allow the user at the terminal device to interact with the resource system for data storage and retrieval.

The authorization system for storing and retrieving data of the invention is used for connecting a terminal device to a resource system established by an application service provider (ASP) via a network, so as to allow a user at the terminal device to store and retrieve application software provided by the ASP.

The authorization system for storing and retrieving data comprises: a database for establishing user's data for storing and retrieving the resource system; a receiving module for receiving user's data for loginning the resource system inputted by the user at the terminal device; an identifying module for comparing the user's data transmitted from the receiving module with the user's data stored in the database; a replying module for responding according to compared results from the identifying module, wherein if no user's data in the database matches the user's data inputted by the user, the replying module sends a message of failure in loginning the resource system to the user at the terminal device, and allows the user to re-input user's data for loginning the resource system; if one of the user's data in the database matches the user's data inputted by the user, the replying module generates a message of permission for loginning the resource system; a managing module having an authorization account for loginning the resource system, wherein the managing module sends an authorization account to the resource system according to the permission message transmitted from the replying module, so as to allow the terminal device to interact with the resource system for data storage and retrieval after the authorization account is identified by the resource system; and a processing module for processing data generated by the interaction between the terminal device and the resource system, so as to display the data in the form of a web page on a browser of the terminal device.

The authorization system of the system can be optionally established in a server host.

### BRIEF DESCRIPTION OF THE DRAWINGS

The present invention can be more fully understood by reading the following detailed description of the preferred embodiments, with reference made to the accompanying drawings wherein:

FIG. 1 is a schematic block diagram showing basic architecture of an authorization system for storing and retrieving data of the invention; and FIG. 2 is a schematic diagram showing the steps for depicting an authorization method for storing and retrieving data in the use of an authorization system for storing and retrieving data of the invention.

### DETAILED DESCRIPTION OF THE PREFERRED EMBODIMENT

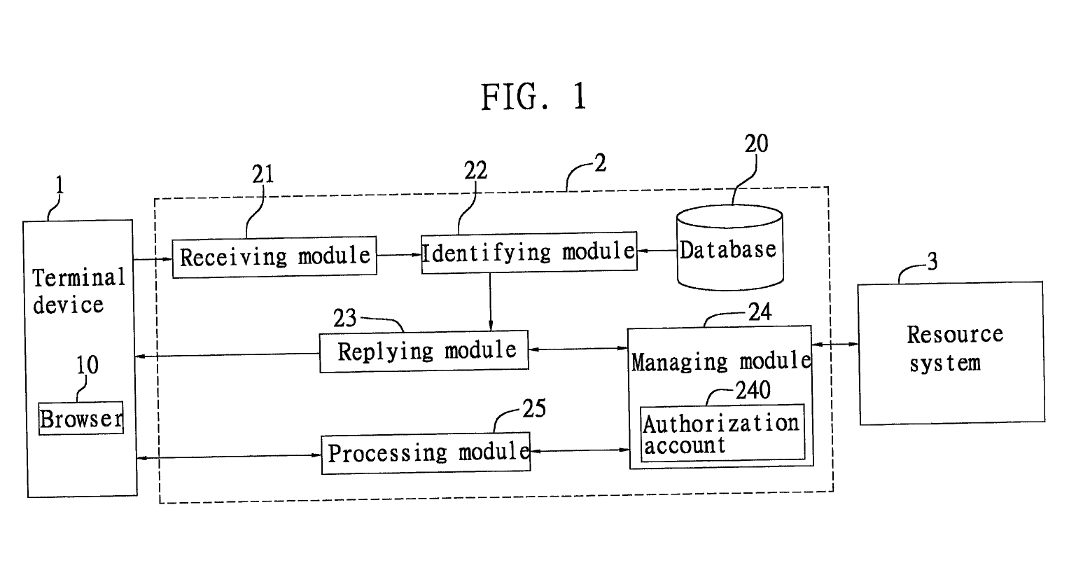

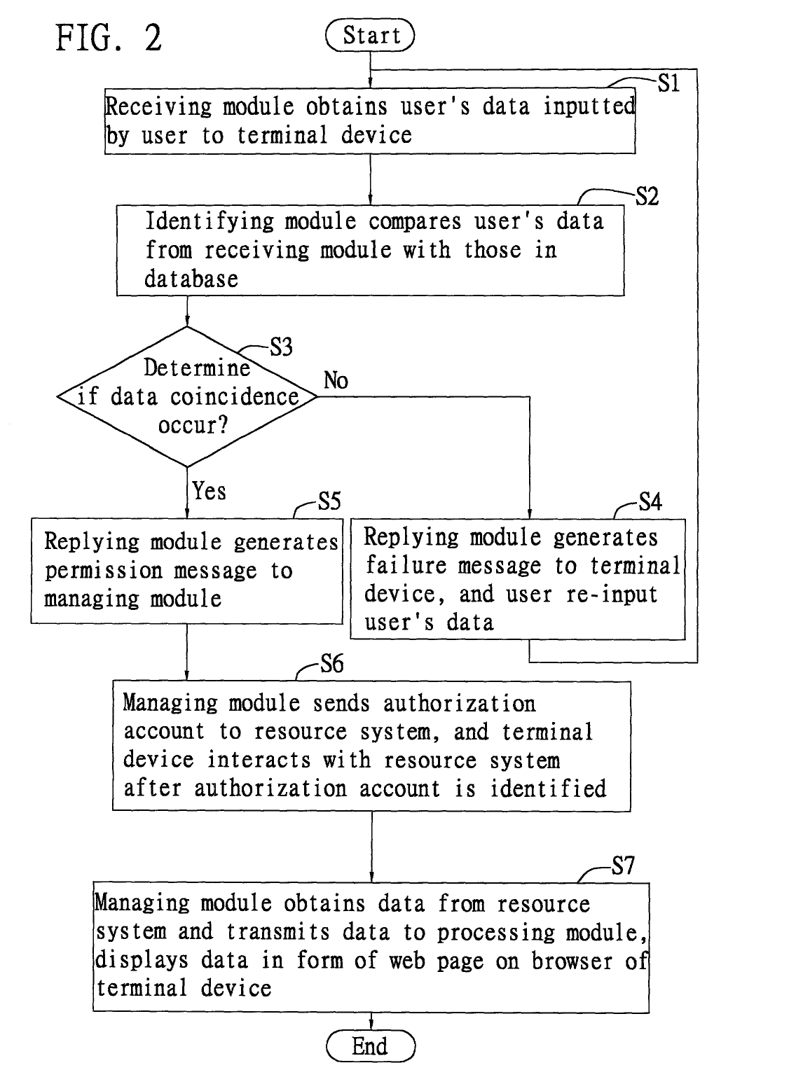

Referring to FIG. 1, it illustrates basic architecture of an authorization system for storing and retrieving data of the invention. As shown in the drawing, the authorization system for storing and retrieving data 2 (bordered by dotted lines) is established between a terminal device 1 and world wide web (WWW) (not shown). The authorization system 2 acts as a server host, and a resource system 3 is an application software provided by an application service provider (ASP), for example, a R/3 internet application components system. The authorization system 2 and the resource system 3 established by the ASP are contained in the WWW. If a user at the terminal device 1 desires to store and retrieve the resource system 3 of the ASP, first, the user needs to input an IP address and name of the authorization system 2 (i.e. server host) to a browser 10 of the terminal device 1, for being connected to the authorization system 2. Then, the authorization system 2 identifies the user at the terminal device 1, and checks an authorized account of the user together with the resource system 3 of the ASP, so as to allow the user to store and retrieve the resource system 3. The authorization system 2 includes a database 20, a receiving module 21, an identifying module 22, a replying module 23, a managing module 24 and a processing module 25.

The database 20 is used to establish a plurality of user's data for storing and retrieving the resource system 3 provided by the ASP, and is pre-constructed by an enterprise. For example, some employees are assigned by the enterprise to store and retrieve the resource system 3, and each user's datum includes a dedicated user's name and a corresponding password, which are pre-established in the authorization system 2.

The receiving module 21 is used to receive user's data inputted for loginning the resource system 3 as requested by the user at the terminal device 1. After the terminal device 1 is connected to the authorization system 2 via a network, the authorization system 2 transmits a table form to the browser 10, for allowing the user at the terminal device 1 to act in response to the table form displayed on the browser 10. That is, when the user at the terminal device 1 inputs the user's data, the browser 10 submits a login request to the authorization system 2 in the use of hyper text transfer protocol (HTTP), and then the authorization system 2 generates a proper response according to the login request and displays associated website data corresponding to the generated response. Since the browser, the HTTP and data processing between the terminal device 1 and the authorization system 2 are conventional, they are not further described herein.

The identifying module 22 is used to compare the user's data transmitted from the receiving module 21 with the user's data in the database 20, wherein the identifying module 22 can store and retrieve the user's data in the database 20 in the use of structured query language (SOL).

The replying module 23 responds according to compared results from the identifying module 22. If no user's data in the database 20 compared by the identifying module 22 matches the user's data inputted by the user at the terminal device 1, the replying module 23 sends a message of failure in loginning the resource system 3 to the user at the terminal device 1, for allowing the user to re-input user's data for loginning the resource system 3. Therefore, if the re-input user's data matches one of the user's data in the database 20, the replying module 23 sends a message of permission for loginning the resource system 3 to the managing module 24.

The managing module 24 contains an authorization account for loginning the resource system 3 provided by the ASP. That is, upon receiving the permission message transmitted from the replying module 23, the managing module 24 sends an authorization account to the resource system 3 of the ASP. After the resource system 3 identifies the authorization account, the terminal device 1 and the resource system 3 can be interacted with each other for data storage and retrieval.

The processing module 25 is used to process data generated in the interaction between the terminal device 1 and the resource system 3 of the ASP, so as to display the data transmitted from the resource system 3 in the form of a web page on the browser 10 of the terminal device 1. When the resource system 3 uses markup language e.g. extensible markup language (XML) for interchanging data between servers, the processing module 25 obtains content and a tag of the XML data, and informs the browser 10 of the terminal device 1 about how to display a web page in the form of the XML data.

The authorization system 2 acts as middleware, for interconnecting two different platforms, i.e. the terminal device 1 and the resource system 3 established by the ASP, as shown in FIG. 1. In the use of the authorization system 2, the user at the terminal device 1 directly issues a storage and retrieval command to the resource system 3 via a web page displayed on the browser 10. The resource system 3 executes the storage and retrieval command, and transmits execution results via the authorization system 2 to the terminal device 1.

Compared to the condition for installing a start-up program in the terminal device 1 and purchasing authorization (an authorization account) for loginning the resource system 3 as depicted in the prior art, in the use of the authorization system 2 of the invention, after the user is identified in identity, the authorization system 2 uses an authorization account for submitting a login request for data storage and retrieval to the resource system 3 established by the ASP, so as to allow the user at the terminal device 1 to store and retrieve the resource system 3. Therefore, the authorization system 2 of the invention can significantly reduce costs for an enterprise in purchasing authorization (the authorization account) from the ASP, and simplifies installation and arrangement of the start-up program.

Referring to FIG. 2, it illustrates an authorization method for storing and retrieving data in the use of the authorization system for storing and retrieving data 2 of the invention. The following description is made with reference to FIGS. 1 and 2. First in step S1, the receiving module 21 obtains user's data inputted via a browser 10 by a user at the terminal device 1. Thereafter, step S2 is followed.

In step S2, the identifying module 22 compares the user's data transmitted from the receiving module 21 with user's data stored in the database 20. Thereafter, step S3 is followed.

In step S3, the identifying module 22 determines if the user's data inputted by the user matches one of the user's data in the database 20. If coincidence occurs, then step S5 is followed; or else, step S4 is followed.

In step S4, the replying module 23 generates and sends a message of failure in loginning the resource system 3 to the terminal device 1, for allowing the user at the terminal device 1 to re-input user's data for loginning the resource system 3. Thereafter, the step S1 is returned.

In step S5, the replying module 23 generates and sends a message of permission for loginning the resource system 3 to the managing module 24. Thereafter, step S6 is followed.

In step S6, the managing module 24 reads an authorization account 240 stored therein and transmits the authorization account 240 to the resource system 3. After identifying the authorization account 240, the resource system 3 authorizes the terminal device 1 to store and retrieve the resource system 3. Thereafter, step S7 is followed.

In step S7, the managing module 24 receives data transmitted from the resource system 3, and sends the data to the processing module 25, so as to allow the processing module 25 to display the data in the form of a web page on the browser 10 of the terminal device 1, wherein the processing module 25 can use XML for interchanging commercial documents, so as to provide internal and external integration for an enterprise.

Therefore, in the use of the authorization method and system of the invention, a client terminal with no authorization is inhibited for storing and retrieving application software provided by an application service provider (ASP), and costs for an enterprise in purchasing authorization from the ASP can be significantly reduced. Besides, employees of the enterprise are allowed to store and retrieve the application software of the ASP via internet, and to interact with a resource system established by the ASP for data storage and retrieval.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An authorization method for storing and retrieving data, applied to an authorization system for connecting a terminal device to a resource system established by an application service provider (ASP) via a network, so as to allow the ASP to authorize a user at the terminal device to interact therewith for data storage and retrieval, wherein the authorization system is preconstructed with a database and an authorization account, while the database includes a plurality of user's data for identifying the user submitting a request for loginning the resource system, and the authorization account is used for authorizing the user to store and retrieve the resource system; the authorization method comprising the steps of:
(1) receiving user's data inputted by the user to the terminal device via the authorization system;
(2) comparing the user's data transmitted from the terminal device with the user's data stored in the database via the authorization system, wherein if no user's data in the database matches the user's data transmitted from the terminal device, then step (3) is followed; if one of the user's data in the database matches the user's data transmitted from the terminal device, then step (4) is followed;
(3) sending a message of failure in loginning the resource system via the authorization system to the terminal device, and allowing the user at the terminal device to re-input user's data for loginning the resource system; then returning to the step (1); and
(4) sending an authorization account via the authorization system to the resource system, and transmitting data generated by the resource system to the terminal device, so as to allow the user at the terminal device to interact with the resource system for data storage and retrieval.

2. The authorization method of claim 1, wherein the user's data include a dedicated user's name and a password corresponding to the user's name.

3. The authorization method of claim 1, wherein the resource system is an enterprise resource planning (ERP) system.

4. The authorization method of claim 3, wherein the ERP system is a R/3 internet application components system for connecting operation of an enterprise to internet.

5. The authorization method of claim 1, wherein the authorization system is established in a server host.

6. The authorization method of claim 5, wherein the authorization system is middleware.

7. The authorization method of claim 1, wherein the authorization system and the resource system are contained in world wide web (WWW).

8. An authorization system for storing and retrieving data, for connecting a terminal device to a resource system established by an application service provider (ASP) via a network, so as to allow a user at the terminal device to store and retrieve application software provided by the ASP; the authorization system comprising:
a database for establishing user's data for storing and retrieving the resource system;
a receiving module for receiving user's data for loginning the resource system inputted by the user at the terminal device;
an identifying module for comparing the user's data transmitted from the receiving module with the user's data stored in the database;
a replying module for responding according to compared results from the identifying module, wherein if no user's data in the database matches the user's data inputted by the user, the replying module sends a message of failure in loginning the resource system to the user at the terminal device, and allows the user to re-input user's data for loginning the resource system; if on of the user's data in the database matches the user's data inputted by the user, the replying module generates a message of permission for loginning the resource system;
a managing module having an authorization account for loginning the resource system, wherein the managing module sends an authorization account to the resource system according to the permission message transmitted from the replying module, so as to allow the terminal device to interact with the resource system for data storage and retrieval after the authorization account is identified by the resource system; and
a processing module for processing data generated by the interaction between the terminal device and the resource system, so as to display the data in the form of a web page on a browser of the terminal device.

9. The authorization system of claim 8, wherein the web page is in the form of extensible markup language XML).

10. The authorization system of claim 8, wherein the user's data include a dedicated user's name and a password corresponding to the user's name.

11. The authorization system of claim 8, wherein the resource system is an enterprise resource planning (ERP) system.

12. The authorization system of claim 11, wherein the ERP system is a R/3 internet application components system for connecting operation of an enterprise to internet.

13. The authorization system of claim 8, wherein the authorization system is established in a server host.

14. The authorization system of claim 13, wherein the authorization system is middleware.

15. The authorization system of claim 8, wherein the authorization system and the resource system are contained in world wide web (WWW).
